(19) United States
(12) Patent Application Publication
(10) Pub. No.: US 2007/0226166 A1
(43) Pub. Date: Sep. 27, 2007

(54) Generic Method of Taking Account of Several Parameters in a Value Judgement Function

(76) Inventors: Christophe Labreuche, Antony (FR); Miniar Hemaissia, Paris (FR)

Correspondence Address: Lowe Hauptman & Berner, 1700 Diagonal Road, Suite 300, Alexandria, VA, 22314, US

(21) Appl. No.: 11/579,835

(22) PCT Filed: May 3, 2005
(86) PCT No.: PCT/EP05/52018

§ 371 Date: Nov. 7, 2006

(30) Foreign Application Priority Data
May 7, 2004 (FR) 04 04956

(51) Int. Cl. G06N 5/04

(52) U.S. Cl. 706/60

(57) ABSTRACT

The method of the invention is a method of taking account of several parameters in a value judgment function, according to which the judgment function depends mainly on a main parameter and in a secondary manner on at least one secondary parameter, and it is characterized by the fact that the model is constructed by asking the expert for the main parameter and the list of secondary parameters, by asking the expert to specify the mono-dimensional function which, for determined values of the secondary parameters, associates the value of the judgment with the main parameter, and by asking the expert how the mono-dimensional judgment function is modified as a function of the determined values of the secondary parameters, that the user provides the values of the main parameter and of the secondary parameters corresponding to at least one option to be evaluated, that the value of the judgment is calculated for each option by determining the mono-dimensional judgment function dependent on the main parameter on the basis of the values of the secondary parameters and by applying this function to the value of the main parameter, and that a list of values of this judgment function for each option is generated for the user.

### RELATED APPLICATIONS

The present Application is based on International Application No. PCT/EP2005/052018, filed on May 3, 2005, which in turn corresponds to France Application No. 04/04956, filed on May 7, 2004, and priority is hereby claimed under 35 USC §119 based on these applications. Each of these applications are hereby incorporated by reference in their entirety into the present application.

### BACKGROUND OF THE INVENTION

1. Field of the Invention

The present invention pertains to a generic method of taking account of several parameters in a value judgment function (subsequently called a judgment function, in most instances, to improve the readability of the description).

2. Description of Related Art

The present invention pertains to the modeling of judgments and assessments that an expert in the domain of application concerned may have regarding a certain quantity. The determination of a model correctly representing the judgments of the expert and the explanation thereof are important elements of the method of the invention. The use of such judgment models is essential in numerous decision aid systems and expert systems.

The approaches of multicriterion decision, of fuzzy set theory and of fuzzy logic rely respectively on the concepts of criterion, of fuzzy set and of membership function. These concepts are very much alike in the sense that they all correspond to a degree belonging usually to the scale (interval) [0,1] and quantifying a value judgment. Thus, a criterion is a value judgment of an action from a certain angle or viewpoint. This amounts for example to knowing, for a rifle marksman practising at a target, whether a shot finishing up 30 cm from the center of the target is regarded as good or bad. A fuzzy set defined on a quantity conveys the degree of membership of a value of the quantity in the fuzzy set. It involves for example knowing with which degree a person measuring 1.75 m can be regarded as belonging to the fuzzy set of “tall people”. Finally, a membership function in fuzzy logic has either the same implication as a fuzzy set, or the implication of the degree of possibility that a parameter can equal a certain value. It then involves knowing, for example, what is the possibility that a lawn is green, having regard to the level of precipitations from rainwater.

By way of example, the present patent application places more stress on the concept of criterion than on those of fuzzy set and of membership function, but it is of course understood that these concepts could be considered in the same way.

In the example of the rifle marksman, it is not possible to assess a deviation of 10 cm without concerning oneself with the context, that is to say, for example, without considering the distance between the marksman and the target, and without knowing if the target is fixed or not. Stated otherwise, each criterion, or fuzzy set, is calculated on the basis of a certain number of parameters, also called variables or attributes. A criterion corresponds to a value judgment associated with a viewpoint. This viewpoint is quantified by a parameter (possibly synthesizing other parameters). This parameter is a particular parameter from among the set of parameters having an influence on the criterion. This parameter is called the main parameter. It has a direct influence on the criterion. The other parameters have a less direct influence. These parameters are called secondary parameters and convey the influence of the context in the evaluation of a criterion. In the example of rifle shooting, the parameter of the same name is of course the main parameter. The main influence conveys the fact that “the smaller the deviation with respect to the center of the target, the better”. This general tendency is modulated by the context. Thus, a deviation of 30 cm may be judged good in a certain context (for example at long range) and bad in another (for example at short range). This is specified concretely through a judgment function which, for each value of the main parameter and of the secondary parameters, indicates the degree of satisfaction (in a scale of the type [0,1]) associated with this criterion.

It is difficult to take the context into account in the judgment functions. The present invention pertains to a method making it possible to solve this difficulty. We are concerned here only with judgment functions dependent on several parameters. We are not concerned with their higher level use in a decision aid system or an expert system. As stated previously, such multi-parameter judgment functions are implemented directly, for example in multicriterion decision aid and in fuzzy logic.

Judgment functions depending only on a single parameter (that is to say not depending on a context) are conventional. The way to obtain them can be detailed in the following way:

In fuzzy set theory and in fuzzy logic, the judgment functions are usually functions of the trapezium or semi-trapezium type (cf. FIG. 1).

For judgment functions of the trapezium type, we go linearly from the satisfaction level 0 to the level 1 (or vice versa). Although it is possible to complicate the judgment functions, only trapeziums are in general used in fuzzy set theory and in fuzzy logic.

To find a methodology making it possible to construct more complex judgment functions (depending only on a single parameter), it is necessary to delve into decision theory and into “measurement” theory. The judgment functions are then generally regarded as piecewise affine (cf. FIG. 2). Such a judgment function is then entirely specified by a finite number of values in the starting set and by the associated judgments.

It therefore remains to ascertain how to determine the judgments for the selected values of the starting set. A judgment function returning a value in a numerical scale (for example the interval [0,1]) is similar to an interval scale on a set. In the measurement sense, such a scale is a scale in which the concept of difference has a sense. The MACBETH methodology (cf. C. Baba e Costa, J. C. Vansnick, “A theoretical framework for measuring attractiveness by a categorical based evaluation technique (MACBETH)”, in MultiCriteria Analysis, J. Climaco eds., Springer-Verlag, Berlin, 1997, pp. 15-24) makes it possible to construct such a scale on the selected values of the starting set by asking the expert to provide an estimation of the difference in satisfaction between each pair of values selected from the ordinal scale composed of the following values: very low, low, moderate, large, very large, extreme. This provides the results of the judgments for the selected values.

The generalization of such judgment functions to the case where several parameters must be taken into account is not easy. It is of course conceivable to describe the space formed of the Cartesian product of the parameters by a set of selected values, to apply a methodology such as MACBETH to these values so as to deduce therefrom the associated judgment and to interpolate over the set of these values so as to deduce therefrom the judgment at any point. However, this procedure is not applicable in practice for two reasons. First of all, this would require defining an overly large number of selected values (which increases exponentially with the number of parameters). But the number of questions to which the expert must respond to execute a methodology of the MACBETH type is of the order of the square of the number of values selected. We see therefore that we very quickly exceed what a human being can support. The second reason is that the results of the multidimensional interpolations are poorly controlled, in particular when, to avoid combinatorial explosion, the values selected do not form a regular sampling of the parameter space.

In the literature one often finds a way to solve this problem, consisting in synthesizing the various parameters (main and secondary) as a very empirical formula consisting usually in combining the various parameters which have previously been divided by a factor to remove the dimension thereof, and the result of this formula becomes the input of the judgment function. In the example of rifle shooting, we denote by x the main parameter (deviation with respect to the center of the target in cm), we denote by y₁, (distance to the target in m) and by y₂ (speed of the target in m/s) the secondary parameters. An exemplary normalization which is very empirical, would be the following:
z=x−y₁/10−y₂/3.

This implies in particular that we are more tolerant by 1 cm for the deviation at the center of the target when shooting at a target which is situated 10 m further away. This type of normalization is of course arbitrary, and no expert can provide this in most cases.

### SUMMARY OF THE INVENTION

The present invention is aimed at a method of taking account of several parameters in a value judgment function making it possible, in particular, to facilitate the work of the expert charged with modeling the judgment functions by avoiding the need for him to provide an overly large quantity of information and by asking him only for information that he will be able to provide, and to facilitate the work of the expert charged with utilizing the model thus obtained by providing him with an explanation of the evaluation of the model.

The method of the invention is a method of taking account of several parameters in a value judgment function for a given domain of application, according to which the judgment function depends mainly on a main parameter and in a secondary manner on at least one secondary parameter, and it is characterized by the fact that the model is constructed by asking the expert in the domain of application considered to provide the main parameter and the list of secondary parameters, and to specify the mono-dimensional function which, for determined values of the secondary parameters, associates the judgment with the main parameter, and by asking this expert how the mono-dimensional judgment function is modified as a function of the determined values of the secondary parameters, that the user provides the values of the main parameter and of the secondary parameters corresponding to at least one option to be evaluated, that the result of the judgment is calculated for each option by determining the mono-dimensional judgment function dependent on the main parameter on the basis of the values of the secondary parameters and by applying this function to the value of the main parameter, and that a list of results of this judgment function for each option is generated for the user.

According to another characteristic of the invention, the mono-dimensional judgment function dependent on the main parameter in a given context is specified on the basis of a finite number of values selected of the main parameter by the expert and of the values that the judgment takes for these values in the preceding context, and the mono-dimensional judgment function for the other contexts is deduced from the preceding function by indicating how the selected values, specifying the mono-dimensional judgment function, depend on the context, the results of the judgment for the selected values remaining the same.

According to another characteristic of the invention, the expert gives the selected values of the main parameter for a certain number of key contexts provided by the expert, and the selected values for a new context are calculated by interpolation on the basis of the key contexts previously provided.

According to another characteristic of the invention, the expert orders the secondary parameters according to their influence on the judgment function, and, to calculate the values selected from the context of the option, a procedure is applied recursively consisting in determining the key contexts stripped of the last parameter together with the associated selected values, by interpolating with respect to the last parameter between all the key contexts reducing to one and the same context stripped of the last parameter, until there is no longer any secondary parameter, and the selected values for the context of the option are thus obtained, and an interpolation is carried out between these selected values and the associated judgments to deduce therefrom the judgment.

According to another characteristic of the invention, the interpolation carried out is linear for the continuous parameters.

According to another characteristic of the invention, the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.

According to another characteristic of the invention, after the expert has provided a reference context, the judgment of the option is evaluated by replacing its context with the reference context, the difference between the judgment of the option and the preceding judgment is evaluated, the important secondary parameters are determined, that is to say those having counted significantly in explaining the difference in the two judgments, and the important secondary parameters are provided to the expert.

According to another characteristic of the invention, the set of differences is split into 2t+1 ordered levels N₋ₜ*, . . . , N₀*, . . . , Nₜ*, the level N₋ₜ* being the worst, the level N₀* being average, that is to say neither good nor bad, Nₜ* being the best level, each level being characterized by a minimum value and a maximum value, for the option the level Nₛ* is determined corresponding to the difference between the results of the two judgments, we indicate when s>0 that the judgment is Nₛ* more tolerant than for the reference context and, when s<0, that the judgment is Nₛ* less tolerant than for the reference context.

According to another characteristic of the invention, for the continuous secondary parameters, the bounds of the interval surrounding the value of the option according to this parameter are determined for which, by replacing the value of the secondary parameter considered with any value belonging to the interval, the difference between the result of the judgment of the option and the result of the judgment of the option obtained by replacing its context with the reference context, is evaluated Nₛ*, a text is generated indicating, for each important secondary parameter, that the judgment is Nₛ* more (if s>0) or less (if s<0) tolerant when this secondary parameter belongs to the previously determined interval, the judgment is indicated not to depend on a certain secondary parameter if the previously calculated bounds for this parameter are equal to the domain of definition of this parameter.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention will be better understood on reading the detailed description of an embodiment, taken by way of nonlimiting example and illustrated by the appended drawing, in which:

FIG. 1 is a set of three charts showing judgment functions of trapezium type, such as may be implemented by the present invention,

FIG. 2 is a simplified chart of a piecewise affine function, such as may be implemented by the present invention,

FIG. 3 is a simplified chart of a mono-dimensional judgment function, for a first determined context, such as may be implemented by the present invention,

FIG. 4 is a simplified chart of a mono-dimensional judgment function, for a second determined context, such as may be implemented by the present invention,

FIG. 5 is a chart showing fuzzy linguistic levels, such as may be implemented by the present invention,

FIG. 6 is a chart showing nonfuzzy linguistic levels, such as may be implemented by the present invention,

FIG. 7 is a chart showing bounds of delimitation of a fuzzy level, such as may be implemented by the present invention,

FIG. 8 is a chart of several curves exhibiting singular points, such as may be implemented by the present invention, and

FIG. 9 is a chart showing the evolution of a judgment as a function of a secondary parameter, such as implemented by the invention.

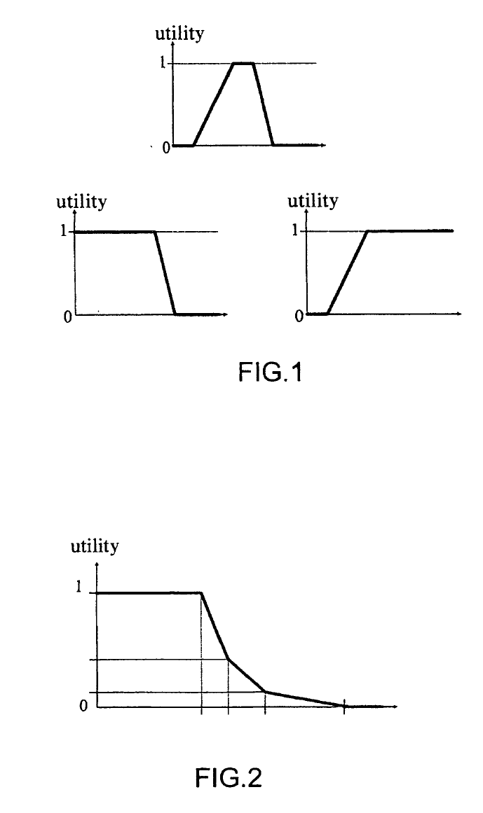

### DETAILED DESCRIPTION OF THE INVENTION

The method of the invention comprises two phases. The first relates to the modeling of multi-parameter judgment functions. The second relates to its utilization on known values of the various parameters. Quite often, these two phases do not involve the same person. For the modeling, it involves advising the model. An expert in the application domain is needed here. Once the model has been established, it is utilized in a decision aid system or expert system. The users of this type of system are not necessarily experts in the application domain. They will simply be called “users” subsequently.

First of all the modeling is succinctly described. The judgment function depends on the main parameter and on the secondary parameters. The secondary parameters will modulate the influence of the main parameter on the judgment, but do not fundamentally change the influence of the main parameter on the judgment function. Stated otherwise, the function which associates the judgment with the main parameter has the same shape (for example decreasing, increasing, bell function, . . . ) whatever the context. The secondary parameters will then render the judgment of the expert more or less tolerant. To model this, we start from a particular context, that called the “reference context” and which comprises particular values of the secondary parameters. We start from the function which associates the reference judgment with the value of the main parameter in the reference context. This mono-dimensional judgment function for another context is deduced from the preceding function by a more or less complex translation.

The function which associates the judgment in the reference context with the main parameter is characterized by the results of the judgment for a certain number of values selected by the expert of the main parameter. When going to another context, the number of selected values as well as the associated judgments remain unchanged. Only the selected values vary with the context. This is how the context is taken into account in the multi-parameter judgment functions.

To utilize the model, it is necessary first of all to calculate the result of the judgment for an option provided by the user. We then know the value of this option according to the set of parameters to be taken into account. To calculate the result of the judgment of this option, we begin by calculating the selected values for the context relating to the option (the context corresponding here to the determined values of the secondary parameters for the chosen option). This is done by interpolating successively according to all the secondary parameters. More precisely, a procedure is applied recursively consisting in determining the values selected from the context stripped of the last parameter by interpolation according to the last parameter, until there is no longer any secondary parameter, in which case one obtains the selected values for the context of the option. It thereafter suffices to interpolate according to the main parameter to deduce therefrom the judgment.

In any decision aid system, the calculations carried out by the system must be explained to the user. In order to explain the global score of an option, the set of possible scores is firstly split into a partition of the possible levels (for example: Very Good, Good, Average, Bad, Very Bad). One thus explains why the option is judged according to a certain level by indicating to the user the ranges of variation according to the main parameter for which, when the score relating to the main parameter is replaced by any value in this range of variation, the judgment of the option belongs to the same satisfaction level as the option. This information relates to the influence of the main parameter on the judgment.

It is necessary also to mention the influence of the context in terms of softening or of hardening of the judgment. For this purpose, a comparison is performed with respect to a reference context. If the judgment of the option has been scored better in the reference context, we indicate that “the judgment is less tolerant”. If the judgment of the option has been scored less well in the reference context, we indicate that “the judgment is more tolerant”. Finally, if the judgment of the option has been scored in the same manner in the reference context, we indicate that “the context has not affected the evaluation”. To back up these explanations, we provide the secondary parameters having contributed most to the deviation that is observed between the context of the option and the reference context. Here again the ranges of variation are determined according to the secondary parameters concerned for which this deviation is important. Finally it is possible to indicate which secondary parameters have no influence on the judgment.

We now examine the modeling of multi-parameter judgment functions. The main parameter is denoted x and the secondary parameters are denoted y₁, . . . , yₚ, where p is the number of secondary parameters. We have p≧1, so that there is at least one secondary parameter. The sought-after judgment function is denoted u(x; y₁, . . . , yₚ).

In order to avoid the drawbacks of the multidimensional interpolation, the method of the invention proposes to carry out only mono-dimensional interpolations so as to properly control the results. To do this, we are concerned with the function, designated “mono-dimensional judgment function”, which associates the value of the judgment u(x; y₁, . . . , yₚ) with the value x of the main parameter in a given context (that is to say for fixed values y₁, . . . , yₚ of the secondary parameters). This mono-dimensional judgment function is denoted U_{y}_{₁}_{, . . . , y}_{ₚ}(x):
U_{y}_{₁}_{, . . . , y}_{ₚ}(x)=u(x; y₁, . . . , yₚ)

We start from the finding that the judgment function u is mainly influenced by the main parameter. The secondary parameters will modulate this influence and render the judgment of the expert more or less tolerant. Thus, the mono-dimensional judgment functions for various contexts have the same shape. They can be deduced from one another by translation.

Hereinafter, I(z; z¹, w¹; . . . ; z^{q}, w^{q}) denotes a function which interpolates at a point z on the basis of the selected values z¹, . . . , z^{q} according to the parameter z and the associated ordinates w¹, . . . , W^{q}.

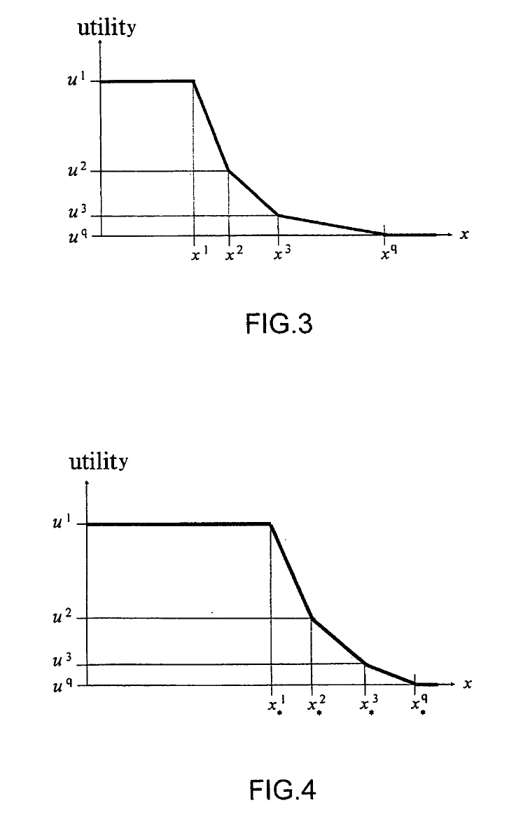

We consider first of all the case where the parameter z is continuous, that is to say corresponds to an interval. It is then possible, for example, to do a linear, quadratic interpolation or else proceed on the basis of splines. In the case of a linear interpolation (cf. FIG. 3), if the selected values are ordered z¹≦ . . . ≦z^{q}, then I may be written:

$$I ( z ; {z}^{1} , {w}^{1} ; ⋯ ; {z}^{q} , {w}^{q} ) = \{ \begin{matrix}{w}^{1} & if z \leq {z}^{1} \\ {w}^{i} + ( {w}^{i + 1} - {w}^{i} ) \frac{z - {z}^{i}}{{z}^{i + 1} - {z}^{i}} & if {z}^{i} \leq z \leq {z}^{i + 1} \\ {w}^{q} & if z \geq {z}^{q}\end{matrix}$$

When the parameter z is ordinal in nature, that is to say described by a list of “labels”, it is no longer possible to perform the arithmetic operation, so that it is no longer possible to carry out genuine interpolations. The labels on the parameter z are denoted Z₁, . . . , Zₙ. As no real interpolation is permitted, the ideal is that the ordinate be provided for each label: I(z; Z₁, w¹; . . . ; Zₙ, wⁿ). We have then I(z; Z₁, w¹; . . . ; Zₙ, wⁿ)=Zᵢ if z=Zᵢ. In practice, a certain number of ordinates may be identical for labels that are close to one another. An interpolation of qualitative nature is then introduced based on an arbitrary order according to the labels. This involves the order in which the labels are entered: Z₁≦ . . . ≦Zₙ. The selected values z¹, . . . , z^{q} necessarily correspond to a subset of the set of labels. We assume that the selected values are ordered according to: z¹≦ . . . ≦z^{q}. The ordinate for a label lying between two selected values is the ordinate of the smallest selected value. This interpolation procedure corresponds to the case where we indicate, in the order Z₁, . . . , Zₙ, only the labels for which the ordinate is different from that of the preceding label. We then obtain:
I(z; z¹, w¹; . . . ; z^{q}, w^{q})=w¹ if z¹≦z<zⁱ⁺¹

The identical shape that the mono-dimensional judgment functions take is represented in the following manner. When going from one context to another, we retain the same number of selected values and only their values change, for example going from x¹, . . . , x^{q} to x¹*, . . . , x^{q}*. Moreover, the judgments associated with these q selected values remain the same whatever the context (cf. FIG. 4).

To specify the judgment function, the expert is asked to provide the number q of selected values as well as the associated judgments u¹, . . . , u^{q}. It then remains to establish in each context y₁, . . . , yₚ which values are the ones selected. We denote by x¹(y₁, . . . , yₚ), . . . , x^{q}(y₁, . . . , yₚ) the values selected in the context y₁, . . . , yₚ. The result of the judgment of the option then equals:

ti u(x; y₁, . . . , yₚ)=U_{y}_{₁}_{, . . . , y}_{ₚ}(x)=I(x; x¹(y₁, . . . , yₚ), u¹; . . . ; x^{q}(y₁, . . . , yₚ), u^{q})

It then remains to specify the values selected x¹(y₁, . . . , yₚ), . . . , x^{q}(y₁, . . . , yₚ) in each context y₁, . . . , yₚ. This is done by letting the expert enter, for a certain number r of contexts, termed key contexts, the corresponding selected values. The i^{th} context considered corresponds to the values denoted y₁[i], . . . , yₚ[i] of the secondary parameters. The selected values for this context are denoted x¹[i], . . . x^{q}[i].

The following table contains the selected values for the key contexts.

| Selected values | | | Context | | |
|---|---|---|---|---|---|
| x^{l}[l] | . . . | x^{q}[l] | yₗ[l] | . . . | yₚ[l] |
| . . . | . . . | . . . | . . . | . . . | . . . |
| x^{l}[l] | . . . | x^{q}[r] | yₗ[r] | . . . | yₚ[r] |

We now describe the way to calculate x¹(y₁, . . . , yₚ), . . . , x^{q}(y₁, . . . , yₚ) in the context y₁, . . . , yₚ on the basis of the preceding values of the proposed model. In order to avoid the drawbacks of the multidimensional interpolation, the method of the invention proposes to interpolate secondary parameter by secondary parameter. To do this, the secondary parameters must be ordered. We assume that the parameter yᵢ goes ahead of the parameter y₂, etc, up to the parameter yₚ. We assume moreover that the key contexts are ordered according to lexicographic order deduced from the preceding order on the secondary parameters, lexicographic order being an order applying to several sort keys, thereby making it possible to obtain a well established order according to each sort key, the keys being themselves ranked (we begin by ranking according to the first key. In the event of equality, we rank according to the second sort key. In the event of equality according to this second key, we rank according to the third, and so on and so forth).

We shall recursively apply a procedure consisting in determining the key contexts stripped of the last parameter, with the corresponding selected values, until there is no longer any secondary parameter, in which case the selected values will directly be the values x¹(y₁, . . . , yₚ), . . . , x^{q}(y₁, . . . , yₚ) searched for.

We begin by determining the key contexts stripped of the last parameter. This gives r′ new key contexts. The i^{th} new context is denoted y′₁[i], . . . , y′ₚ₋₁[i]. Each of these new key contexts corresponds to the restriction of one or of several key contexts stripped of the last parameter: y₁[k], . . . , yₚ₋₁[k]. As the cases are ordered according to lexicographic order, the set of indices k of the key contexts corresponding to y′₁[i], . . . , y′ₚ₋₁[i] are of the form kᵢ, kᵢ+1, . . . , kᵢ*. We therefore have:
y′₁[i]=y₁[kᵢ]=y₁[kᵢ+1]= . . . =y₁└kᵢ*┘
. . .
y′ₚ₋₁[i]=yₚ₋₁[k₁]=yₚ₋₁[k₁+1]= . . . =yₚ₋₁[kᵢ*]

We obtain the new associated selected values x′¹[i], . . . x′^{q}[i] by interpolation according to the last secondary parameter:
x′¹[i]=I(yₚ; yₚ[kᵢ], x′¹[kᵢ]; yₚ[kᵢ+1], x′¹[kᵢ+1]; . . . ; yₚ[kᵢ*], x′¹[kᵢ*])
. . .
x′^{q}[i]=I(yₚ; yₚ[kᵢ],x′^{q}[kᵢ]; yₚ[kᵢ+1],x′^{q}[kᵢ+1]; . . . ; yₚ[kᵢ*], x′^{q}[kᵢ*])

We thus obtain the new key contexts stripped of the last parameter, with the corresponding selected values, as described in the following table:

| | | | Context stripped of the last secondary | | |
|---|---|---|---|---|---|
| Selected values | | | parameter | | |
| x′^{l}[l] | . . . | x′^{q}[l] | y′ₗ[l] | . . . | y′ₚ₋ₗ[l] |
| . . . | . . . | . . . | . . . | . . . | . . . |
| x′^{l}[r′] | . . . | x′^{q}[r′] | y′ₗ[r′] | . . . | y′ₚ₋ₗ[r′] |

We repeat the same procedure until there is no longer any secondary parameter.

By way of illustration, we return to the example of rifle shooting and we consider that the expert estimates that four values of the judgment must be provided. Based on a key context (for example zero speed and distance of 10 m), the four values of the judgment are determined via a procedure of the MACBETH type:

Values of the judgment

| | | | |
|---|---|---|---|
| 1 | 0.5 | 0.2 | 0 |

The two secondary parameters are the speed and the distance. The secondary parameter “speed” is the most significant. The expert provides the following table:

| Selected values | | | | Speed | | Distance | |
|---|---|---|---|---|---|---|---|
| 10 cm | 15 cm | 20 cm | 30 cm | 0 | m/s | 10 | m |
| 15 cm | 20 cm | 25 cm | 40 cm | 10 | m/s | 10 | m |
| 20 cm | 25 cm | 30 cm | 45 cm | 20 | m/s | 10 | m |
| 30 cm | 35 cm | 40 cm | 55 cm | 20 | m/s | 30 | m |
| 35 cm | 40 cm | 45 cm | 60 cm | 20 | m/s | 100 | m |

We shall now explain how to calculate the judgment with the values x=35 cm, y₁=15 m/s and y₂=20 m. As described previously, the first step consists in determining a table by removing the last main parameter:

| | |
|---|---|
| Selected values | Speed |

| | | | | | |
|---|---|---|---|---|---|
| 10 cm | 15 cm | 20 cm | 30 cm | 0 | m/s |
| 15 cm | 20 cm | 25 cm | 40 cm | 10 | m/s |
| 25 cm | 30 cm | 35 cm | 50 cm | 20 | m/s |

For example, the last selected value for the context reduced by 20 m/s equals I(20 m; 10 m, 45 cm; 30 m, 55 cm; 100 m, 60 cm)=50 cm.

By repeating this on the following parameter (speed), we obtain the selected values:

Selected values

| | | | |
|---|---|---|---|
| 20 cm | 25 cm | 30 cm | 45 cm |

From this we deduce that the judgment equals I(35 cm; 20 cm, 1; 25 cm, 0.5; 30 cm, 0.2; 45 cm, 0)=0.4.

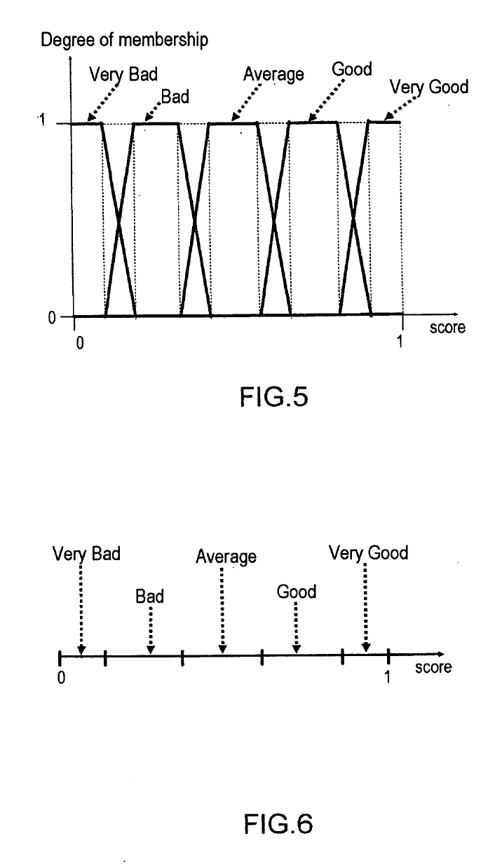

One now wishes to explain the value of the result of the judgment, that is to say explain why u(x; y₁, . . . , yₚ) equals a certain value v. It is of no interest to explain the exact value of v. On the other hand, the user desires to know why v is judged rather bad, rather good or average. We want therefore to explain why v belongs to a certain fuzzy level. Let us assume that we have available 2m+1 fuzzy levels: N₋ₘ, . . . , N₀, . . . Nₘ. The level N₋ₘ is the worst (VERY BAD), N₀ is average (neither good nor bad) and Nₘ is the best level (VERY GOOD). In fuzzy set theory, it is conventional to model such levels by fuzzy sets (cf. FIG. 5). In order to avoid the use of “linguistic modifiers” (which are inevitable for characterizing the intermediate values between two fuzzy sets) which would add additional complexity to the explanation, we represent each linguistic level by a nonfuzzy set: Nᵢ=]mᵢ, Mᵢ]. The linguistic levels form a tiling if we assume that for any i, Mᵢ=mᵢ₊₁. This corresponds to FIG. 6. Any score whatsoever then belongs to a single level with a degree 1.

Knowing v, we determine first of all the corresponding fuzzy level, that is to say the integer iε{−m, . . . , m} such that vεNᵢ. The first part of the explanation relates to the mono-dimensional judgment function for the context of the option. It is not actually possible to provide a real explanation. We propose rather to provide the user with the bounds of the interval surrounding x values out of those of the main parameter and for which the result of the judgment is the level Nᵢ. The second part of the explanation consists in giving an indication of the influence of the context on the evaluation. This involves saying whether the evaluation is more or less tolerant in the current context in comparison with a reference context, and to explain why.

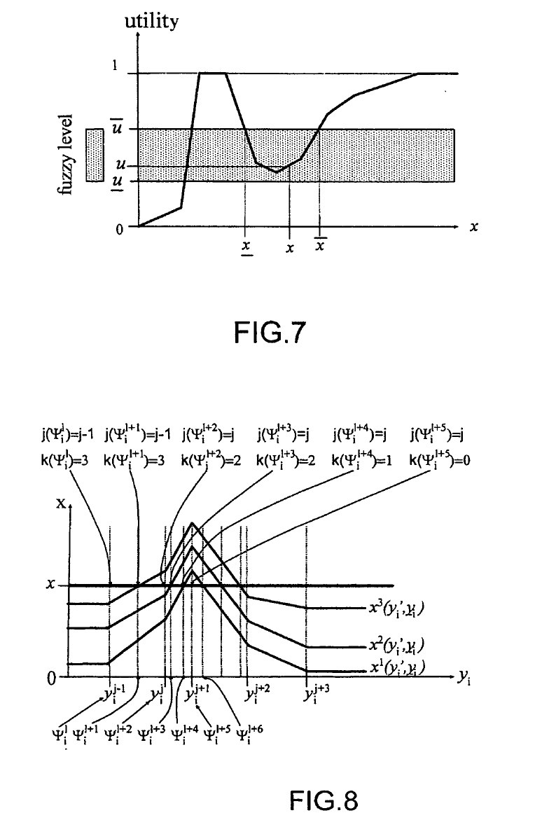

We are first of all concerned with the main argument of the explanation. The linguistic level corresponding to the judgment equals Nᵢ. The user is provided with the bounds of the interval surrounding x values out of those of the main parameter and for which the result of the mono-dimensional judgment U_{y}_{₁}_{, . . . , y}_{ₚ}(x′) is Nᵢ for any x′ situated in this interval (cf. FIG. 7). These bounds are denoted x and x̅. To calculate the minimum bound x, it suffices successively to traverse the straight segments of U_{y}_{₁}_{, . . . , y}_{ₚ}(x′), from right to left, starting from that containing x, until the current segment is not entirely included in Nᵢ. The bound x is then the abscissa of the straight segment cutting Nᵢ. We proceed in a similar manner to calculate x̅, starting to the right of x.

The principle of the explanation is therefore to generate the following sentence:

“Between x and x̅, the value of the main parameter is judged Nᵢ.”

We see that the values x and x̅ occurring in the explanation do not correspond at all to the values used by experts to specify judgment functions.

We now examine the argument relating to the context, that is to say to the second part of the explanation. It relates to the influence of the context on the evaluation. To be able to indicate whether the evaluation is more or less tolerant in the current context, it is necessary to compare it with a reference context. The values of the secondary parameters for this reference context are denoted y₁*, . . . , yₚ*. We write v=u(x; y₁, . . . , yₚ) and v*=u(x; y₁*, . . . , yₚ*).

Concerning the comparison of v with the value v* for the reference context, we reuse the linguistic satisfaction levels N₋ₘ, . . . , N₀, . . . , Nₘ forming a partition of the interval [0,1]. We are concerned with the level to which the difference v−v* belongs. As fuzzy levels are generally considered in the interval [0,1] and since the difference v−v* belongs to [−1,1], we normalize this difference so as to obtain a number between 0 and 1. According to the invention, we propose for example:

$$\frac{1}{2} ( v - {v}^{*} ) + \frac{1}{2} .$$

The level to which

$$\frac{1}{2} ( v - {v}^{*} ) + \frac{1}{2}$$

belongs is denoted N_{g}, gε{−m, . . . , m}. We have three cases:
When v−v* belongs to the level N₀, v is not very different from v*. We therefore obtain a judgment close to what would have been obtained in the reference context. The context has not been a determining factor in the result of the judgment.
When v−v* belongs to a positive level N_{g}, gε{1, . . . , m}, v is (very) significantly greater than v*. The judgment in the context of the option is therefore more tolerant than with what we would have had with the reference context.
When v−v* belongs to a negative level N_{g}, gε{−m, , . . . , −1}, v is (very) significantly less than v*. The judgment in the context of the option is therefore less tolerant than with what we would have had with the reference context.

In a similar way to what was done for the main argument, the argument about the influence of the context will consist in providing the user, for each secondary parameter i, with the bounds of the interval surrounding yᵢ, of those values of the secondary parameter N^{o} i for which the difference:

$$\frac{1}{2} ( u ( x ; {y}_{1} , … , {y}_{i - 1} , {y}_{i}^{′} , {y}_{i + 1} , … , {y}_{n} ) - {v}^{*} ) + \frac{1}{2}$$

is judged according to the fuzzy level N_{g} for any y′ᵢ in this interval. The bounds of this interval surrounding yᵢ are denoted yᵢ and y̅ᵢ̅. The lower and upper bounds of the fuzzy set N_{g} are respectively denoted n_{g} and m_{g}. We return to the previous three cases:
When g>0, the judgment is more tolerant. We are in fact concerned with the values for which:

$$\frac{1}{2} ( u ( x ; {y}_{1} , … , {y}_{i - 1} , {y}_{i}^{′} , {y}_{i + 1} , … , {y}_{n} ) - {v}^{*} ) + \frac{1}{2}$$
is judged at least N_{g}, that is to say judged N_{g} or N_{g+1} or . . . or Nₘ. This involves the values for which the tolerance level is greater than or equal to N_{g}. We seek therefore yᵢ and y̅ᵢ̅ for which for any yᵢ′ε[yᵢ, y̅ᵢ̅], we have: u(x; y₁, . . . , yᵢ₋₁, yᵢ′, yᵢ₊₁, . . . , yₙ)ε[U*, U*], where U*=v*−1+2n_{q} and U*=1.
When g<0, the judgment is more intolerant. We are in fact concerned with the values for which

$$\frac{1}{2} ( u ( x ; {y}_{1} , … , {y}_{i - 1} , {y}_{i}^{′} , {y}_{i + 1} , … , {y}_{n} ) - {v}^{*} ) + \frac{1}{2}$$
is judged at most N_{g}, that is to say judged N_{g} or N_{g-1}, or . . . or N₋ₘ. This involves the values for which the intolerance level is greater than or equal to N_{g}. We seek therefore yᵢ and y̅ᵢ̅ for which for any yᵢ′ε[yᵢ, y̅ᵢ̅], we have u(x; y₁, . . . , yᵢ₋₁, yᵢ′, yᵢ₊₁, . . . , yₙ)ε[U*, U*], where U*=0 and U*=v*−1+2m_{q}.
When g=0, we seek on the other hand to ascertain whether the parameter does or does not influence the judgment. We thus seek the values according to the parameter N^{o}i for which we remain in the same level N_{g}. We are in fact concerned with the values for which

$$\frac{1}{2} ( u ( x ; {y}_{1} , … , {y}_{i - 1} , {y}_{i}^{′} , {y}_{i + 1} , … , {y}_{n} ) - {v}^{*} ) + \frac{1}{2}$$
is judged N_{g}. We therefore seek yᵢ and y̅ᵢ̅ for which for any yᵢ′ε[yᵢ, y̅ᵢ̅], we have: u(x; y₁, . . . , yᵢ₋₁, yᵢ′, yᵢ₊₁, . . . , yₙ)ε[U*, U*], where U*=v*−1+2n_{q} and U*=v*−1+2m_{q}.

As the various parameters have diverse influences on the judgment, it is not opportune to provide the user with the intervals for all the secondary parameters. It is necessary to display the intervals only for the “important” secondary parameters, that is to say those having counted in the result of the judgment. The determination of the important secondary parameters is unnecessary when k=0 since v is then not very different from v*.

When k≠0 (v is significantly different from v*), we determine from among P={1, . . . , p}, the set C of important secondary parameters, that is to say those which have contributed significantly to the difference v−v*. For this purpose, we define a set function μ on the set P. For A⊂P, μ(A) is the difference between the result of the judgment of the option for which the values according to the secondary parameters of A are replaced with the values taken by the reference context according to these parameters and according to v*. We have μ(Ø)=0 and μ(N)=v−v*; μ is a capacity, or fuzzy measure. The concept of capacity is known in particular in the domains of decision in uncertainty and risk, multicriterion decision and cooperative game theory. The capacities considered in these domains are monotonic, that is to say that we have:
μ(A∪{i})≧μ(A)
for any subset A of P. In the present case, μ is not necessarily monotonic, since the secondary parameters do not necessarily contribute all positively to the global judgment.

As has just been seen, this concept of capacity is used in the game theory. The set P then corresponds to the set of the players and μ(A) are the winnings of the game when all the players A play together. In particular, μ(P) are the winnings of the game when all the players collaborate and play together. A very important concept in game theory makes it possible to determine the global contribution of each player to the game. For a player iεP this contribution is quantified through the Shapley value:

$${ϕ}_{i} ( μ ) = {\sum }_{A ⋐ P - \{ i \}} \frac{\vert A \vert ! ( n - \vert A \vert - 1 ) !}{( n - 1 ) !} [ μ ( A ⋃ \{ i \} ) - μ ( A ) ]$$

where |A| designates the cardinality of the set A. This quantity can be directly transposed to the present case, thus giving the contribution of each secondary parameter to the difference v−v*. It may happen that a value φᵢ(μ) is negative, in which case the corresponding secondary parameter will globally contribute negatively to the global judgment. An essential property of the Shapley value is that the indices φᵢ(μ) correspond to an equitable distribution of the maximum value attainable μ(P)=v−v*, in the sense that:

$${\sum }_{i ∈ P} {ϕ}_{i} ( μ ) = v - {v}^{*}$$

From this we deduce that the average value taken by φᵢ(μ) equals (v−v*)/p. The important secondary parameters are then those whose value of φᵢ(μ) is greater than (v−v*)/p. The set of these parameters is denoted C.

Once the set C of important secondary parameters is determined, we seek to determine the bounds yᵢ and y̅ᵢ̅. This is possible only for the continuous parameters. To calculate these bounds, it is necessary to explicitly describe the function which associates the judgment u(x; y₁, . . . , yᵢ₋₁, y′ᵢ, yᵢ₊₁, . . . , yₚ) with the value of y′ᵢ.

It has been seen that the way in which the multi-parameter judgment function is calculated is done by successive interpolations starting from the last secondary parameter and ending with the first secondary parameter, and by using the list of values selected from the key contexts. Thus, at the level of the secondary parameter N^{o}i, the interpolation is done on the basis of the present values on the parameter N^{o}i in the base of the key contexts. Thus, the functions which associate x¹(y₁, . . . , yᵢ₋₁, y′ᵢ, yᵢ₊₁, . . . , yₚ), . . . , x^{q}(y₁, . . . , yᵢ₋₁, y′ᵢ, yᵢ₊₁, . . . , yₚ) with yᵢ′ are piecewise affine. They are affine between two values of the key contexts. Let Σᵢ be the set of these values:
Σᵢ={yᵢ[1], . . . , yᵢ[r]}
We remove the double values from Σᵢ. The number of different elements of Σᵢ is denoted r′. We have r′≦r. These values are denoted yᵢ¹, . . . , yᵢ^{r′:}
Σ={yᵢ¹, . . . , yᵢ^{r′}}
We assume that this numbering complies with the order: yᵢ¹≦ . . . ≦yᵢ^{r′}. We write for any jε{1, . . . , q} and any kε{1, . . . , r′}:
xⱼ(yᵢ^{k}, y₋ᵢ):=x^{j}(y₁, . . . , yᵢ₋₁, yᵢ^{k}, yᵢ₊₁, . . . , yₚ)
Thus, the function which associates x^{j}(yᵢ′, y₋ᵢ):=x^{j}(y₁, . . . , yᵢ₋₁, y′ᵢ, yᵢ₊₁, . . . , yₚ) with yᵢ′ is characterized by the pairs:
(yᵢ^{k}, x^{j}(yᵢ^{k}, y₋ᵢ)) for kε{1, . . . , r′}
The value of the judgment is calculated by interpolating between the values of x^{j}. Accordingly, as the x^{j} depend in a piecewise affine manner on yᵢ′, the judgment depends in a piecewise hyperbolic manner on yᵢ′. The singularity points of this function are the values of Σᵢ as well as the intersections of the functions x¹(yᵢ′, y₋ᵢ), . . . , x^{q}(yᵢ′, y₋ᵢ) with the value x. Thus we introduce the set, denoted Ψᵢ, containing the singularity points according to the secondary parameter N^{o}i: Ψᵢ={Ψᵢ¹, . . . , Ψᵢₛ}. More precisely, Ψᵢ contains the values yᵢ¹, . . . , yᵢ^{r′} of Σᵢ, as well as the values yᵢ′ for which x¹(yᵢ′, y₋ᵢ)=x or . . . or x^{q}(yᵢ′, y₋ᵢ)=x. The values of Ψᵢ are assumed to be ordered: Ψᵢ¹≦. . . ≦Ψᵢ⁵. For any 1ε{1, . . . , s}, we denote by K(Ψᵢ¹) the index kε{0, . . . , q} such that x lies between x^{k}(Ψᵢ¹, y₋ᵢ) and x^{k+1}(Ψᵢ¹, y₋ᵢ). We have K(Ψᵢ¹)=0 if x<x¹(Ψᵢ¹, y₋ᵢ), and K(Ψᵢ¹)=q if x>x^{q}(Ψᵢ¹, y₋ᵢ). We write k(Ψᵢ¹)=min(K(Ψᵢ¹),K(Ψᵢ¹⁺¹)). For any 1ε{1, . . . , s}, we denote by J(Ψᵢ¹) the index jε{1, . . . , r′−1} such that Ψᵢ¹ lies between yᵢ^{j} and yᵢ^{j+1}. We write j(Ψᵢ¹)=min(J(Ψᵢ¹), J(Ψᵢ¹⁺¹)). FIG. 8 shows the various notions above relating to singular points.

The function which associates with u(x; y₁, . . . , yᵢ₋₁, y′ᵢ, yᵢ₊₁, . . . , yₚ) with yᵢ′ is hyperbolic between two successive values Ψᵢ¹ and Ψᵢ¹⁺¹ of Ψᵢ. For yᵢ′ε[Ψᵢ₁, Ψᵢ¹⁺¹], we have:

$${x}^{k ( {Ψ}_{i}^{l} )} ( {y}_{i}^{′} , {y}_{- i} ) = {x}^{k ( {Ψ}_{i}^{l} )} ( {y}_{i}^{j ( {Ψ}_{i}^{l} )} , {y}_{- i} ) + \\ [ {x}^{k ( {Ψ}_{i}^{l} )} ( {y}_{i}^{j ( {Ψ}_{i}^{l} ) + 1} , {y}_{- i} ) - {x}^{k ( {Ψ}_{i}^{l} )} ( {y}_{i}^{j ( {Ψ}_{i}^{l} )} , {y}_{- i} ) ] \times \frac{{y}_{i}^{′} - {y}_{i}^{j ( {Ψ}_{i}^{l} )}}{{y}_{i}^{j ( {Ψ}_{i}^{l} ) + 1} - {y}_{i}^{j ( {Ψ}_{i}^{l} )}}$$

$${x}^{k ( {Ψ}_{i}^{l} ) + 1} ( {y}_{i}^{′} , {y}_{- i} ) = {x}^{k ( {Ψ}_{i}^{l} ) + 1} ( {y}_{i}^{j ( {Ψ}_{i}^{l} )} , {y}_{- i} ) + \\ [ {x}^{k ( {Ψ}_{i}^{l} ) + 1} ( {y}_{i}^{j ( {Ψ}_{i}^{l} ) + 1} , {y}_{- i} ) - {x}^{k ( {Ψ}_{i}^{l} ) + 1} ( {y}_{i}^{j ( {Ψ}_{i}^{l} )} , {y}_{- i} ) ] \times \frac{{y}_{i}^{′} - {y}_{i}^{j ( {Ψ}_{i}^{l} )}}{{y}_{i}^{j ( {Ψ}_{i}^{l} ) + 1} - {y}_{i}^{j ( {Ψ}_{i}^{l} )}}$$

We put:

$${α}^{k ( {Ψ}_{i}^{l} )} = \frac{⌊ {x}^{k ( {Ψ}_{i}^{l} )} ( {y}_{i}^{j ( {Ψ}_{i}^{l} ) + 1} , {y}_{- i} ) - {x}^{k ( {Ψ}_{i}^{l} )} ( {y}_{i}^{j ( {Ψ}_{i}^{l} )} , {y}_{- i} ) ⌋}{{y}_{i}^{j ( {Ψ}_{i}^{l} ) + 1} - {y}_{i}^{j ( {Ψ}_{i}^{l} )}}$$

$${β}^{k ( {Ψ}_{i}^{l} )} = {x}^{k ( {Ψ}_{i}^{l} )} ( {y}_{i}^{j ( {Ψ}_{i}^{l} )} , {y}_{- i} ) - {y}_{i}^{j ( {Ψ}_{i}^{l} )} {α}^{k ( {Ψ}_{i}^{l} )}$$

$${α}^{k ( {Ψ}_{i}^{l} ) + 1} = \frac{[ {x}^{k ( {Ψ}_{i}^{l} ) + 1} ( {y}_{i}^{j ( {Ψ}_{i}^{l} ) + 1} , {y}_{- i} ) - {x}^{k ( {Ψ}_{i}^{l} ) + 1} ( {y}_{i}^{j ( {Ψ}_{i}^{l} )} , {y}_{- i} ) ]}{{y}_{i}^{j ( {Ψ}_{i}^{l} ) + 1} - {y}_{i}^{j ( {Ψ}_{i}^{l} )}}$$

$${β}^{k ( {Ψ}_{i}^{l} ) + 1} = {x}^{k ( {Ψ}_{i}^{l} ) + 1} ( {y}_{i}^{j ( {Ψ}_{i}^{l} )} , {y}_{- i} ) - {y}_{i}^{j ( {Ψ}_{i}^{l} )} {α}^{k ( {Ψ}_{i}^{l} ) + 1}$$

Thus, we have:
x^{k(Ψ}^{ᵢ}^{¹}⁾(y′ᵢ, y₋ᵢ)=α^{k(Ψ}^{ᵢ}^{¹}⁾y′ᵢ+β^{k(Ψ}^{ᵢ}^{¹}⁾
x^{k(Ψ}^{ᵢ}^{¹}⁾⁺¹(y′ᵢ, y₋ᵢ)=a^{k(Ψ}^{ᵢ}^{¹}⁾⁺¹y′ᵢ+β^{k(Ψ}^{ᵢ}^{¹}⁾⁺¹
According to the definition of k(Ψᵢ¹), we have: x^{k(Ψ}^{ᵢ}^{¹}⁾(y′ᵢ, y₋ᵢ)≦x≦x^{k(Ψ}^{ᵢ}^{¹}⁾⁺¹(y′ᵢ, y₋ᵢ). Consequently, the result of the judgment is calculated by interpolation between these two values:

$$u ( x ; {y}_{1} , … , {y}_{i - 1} , {y}_{i}^{′} , {y}_{i + 1} , … , {y}_{p} ) = {u}^{k ( {Ψ}_{i}^{l} )} + [ {u}^{k ( {Ψ}_{i}^{l} ) + 1} - {u}^{k ( {Ψ}_{i}^{l} )} ] \times \frac{x - {x}^{k ( {Ψ}_{i}^{l} )} ( {y}_{i}^{′} , {y}_{- i} )}{{x}^{k ( {Ψ}_{i}^{l} ) + 1} ( {y}_{i}^{′} , {y}_{- i} ) - {x}^{k ( {Ψ}_{i}^{l} )} ( {y}_{i}^{′} , {y}_{- i} )}$$

Let:
a₁=α^{k(Ψ}^{ᵢ}^{¹}⁾×(u^{k(Ψ}^{ᵢ}^{¹}⁾⁺¹−u^{k(Ψ}^{ᵢ}^{¹}⁾)
b₁=(β^{k(Ψ}^{ᵢ}^{¹}⁾−x)×(u^{k(Ψ}^{ᵢ}^{¹}⁾⁺¹−u^{k(Ψ}^{ᵢ}^{¹}⁾)
c₁=α^{k(Ψ}^{ᵢ}^{¹}⁾−α^{k(Ψ}^{ᵢ}^{¹}⁾⁺¹
d₁=β^{k(Ψ}^{ᵢ}^{¹}⁾−β^{k(Ψ}^{ᵢ}^{¹}⁾⁺¹
e₁=u^{k(Ψ}^{ᵢ}^{¹}⁾
We then have for any yᵢ¹ε[Ψᵢ¹, Ψᵢ¹⁺¹]:

$$u ( x ; {y}_{1} , … , {y}_{i - 1} , {y}_{i}^{′} , {y}_{i + 1} , … , {y}_{p} ) = \frac{{a}_{l} {y}_{i}^{′} + {b}_{l}}{{c}_{l} {y}_{i}^{′} + {d}_{l}} + {e}_{l}$$

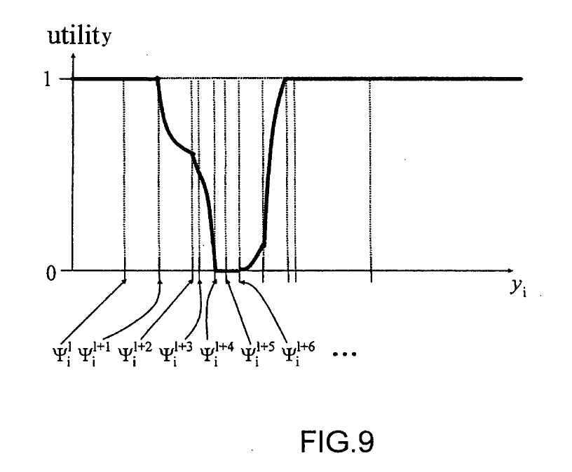

For yᵢ′≦Ψᵢ¹, we have:
u(x; y₁, . . . , yᵢ₋₁, y′ᵢ, yᵢ₊₁, . . . , yₚ)=u^{k(Ψ}^{ⱼ}^{¹}⁾
For yᵢ′≧Ψᵢ⁵, we have:
u(x; y₁, . . . , yᵢ₋₁, y′ᵢ, yᵢ₊₁, . . . , yₚ)=u^{k(Ψ}^{ⱼ}^{¹}⁾
FIG. 9 shows the function which associates u(x; y₁, . . . , yᵢ₋₁, y′ᵢ, yᵢ₊₁, . . . , yₚ) with yᵢ′.

It is now possible to calculate the bounds yᵢ and y̅ᵢ̅. Recall that these bounds are characterized by the fact that it is the largest interval containing yᵢ such that for any yᵢ′ε[yᵢ, y̅ᵢ̅], we have:
u(x; y₁, . . . , yᵢ₋₁, yᵢ′, yᵢ₊₁, . . . , yₙ)ε[U*, U*].

We determine the index 1*ε{1, . . . , s−1} such that yᵢᵢε[Ψᵢ¹*, Ψᵢ¹*₊₁]. If yᵢ≦Ψᵢ¹, we put 1*=0, and if yᵢ≧Ψᵢ⁵ then we put 1*=s.

We begin by describing how to determine yᵢ. We have yᵢ≧yᵢ. Therefore we traverse the intervals [Ψᵢ¹, Ψᵢ¹⁺¹] in decreasing order of 1 starting from 1*. If 1*=0, for any yᵢ′≦yᵢ we have:
u(x; y₁, . . . , yᵢ₋₁, yᵢ′, yᵢ₊₁, . . . , yₙ)ε[U*, U*].
Therefore, yᵢ is equal to the minimum bound of the domain of definition of the secondary parameter N^{o}i. If 1*≠0, we seek 1ε{1, . . . , 1*} the closest possible to 1* such that

$$\frac{{a}_{l} {Ψ}_{i}^{l} + {b}_{l}}{{c}_{l} {Ψ}_{i}^{l} + {d}_{l}} + {e}_{l} ∉ [ {U}_{*} , {U}^{*} ] .$$

If such an 1 does not exist, yᵢ is equal to the minimum bound of the domain of definition of the secondary parameter N^{o}i. Otherwise, we have:

$$\underline{{y}_{i}} = \{ \begin{matrix}\frac{( {U}_{*} - {e}_{l} ) {d}_{l} - {b}_{l}}{{a}_{l} - ( {U}_{*} - {e}_{l} ) {c}_{l}} & if & \frac{{a}_{l} {Ψ}_{i}^{l} + {b}_{l}}{{c}_{l} {Ψ}_{i}^{l} + {d}_{l}} + {e}_{l} < {U}_{*} \\ \frac{( {U}^{*} - {e}_{l} ) {d}_{l} - {b}_{l}}{{a}_{l} - ( {U}^{*} - {e}_{l} ) {c}_{l}} & if & \frac{{a}_{l} {Ψ}_{i}^{l} + {b}_{l}}{{c}_{l} {Ψ}_{i}^{l} + {d}_{l}} + {e}_{l} > {U}^{*}\end{matrix}$$

We now determine y̅ᵢ̅. We have yᵢ≦ y̅ᵢ̅. Therefore we traverse the intervals [Ψᵢ¹, Ψᵢ¹⁺¹] in increasing order of 1 starting from 1*. If 1*=s, for any y′≧yᵢ, we have:
u(x; y₁, . . . , yᵢ₋₁, yᵢ′, yᵢ₊₁, . . . , yₙ)ε[U*, U*]
Therefore, y̅ᵢ̅ is equal to the maximum bound of the domain of definition of the secondary parameter N^{o}i. If 1*≠s, we seek 1ε{1*, . . . , s−1} the closest possible to 1* such that

$$\frac{{a}_{l} {Ψ}_{i}^{l + 1} + {b}_{l}}{{c}_{l} {Ψ}_{i}^{l + 1} + {d}_{l}} + {e}_{l} ∉ [ {U}_{*} , {U}^{*} ] .$$

If such an 1 does not exist, y̅ᵢ̅ is equal to the maximum bound of the domain of definition of the secondary parameter N^{o}i. Otherwise, we have:

$$\overline{{y}_{i}} = \{ \begin{matrix}\frac{( {U}_{*} - {e}_{l} ) {d}_{l} - {b}_{l}}{{a}_{l} - ( {U}_{*} - {e}_{l} ) {c}_{l}} & if & \frac{{a}_{l} {Ψ}_{i}^{l + 1} + {b}_{l}}{{c}_{l} {Ψ}_{i}^{l + 1} + {d}_{l}} + {e}_{l} < {U}_{*} \\ \frac{( {U}^{*} - {e}_{l} ) {d}_{l} - {b}_{l}}{{a}_{l} - ( {U}^{*} - {e}_{l} ) {c}_{l}} & if & \frac{{a}_{l} {Ψ}_{i}^{l + 1} + {b}_{l}}{{c}_{l} {Ψ}_{i}^{l + 1} + {d}_{l}} + {e}_{l} > {U}^{*}\end{matrix}$$

We are now ready to generate the explanation. If g≠0, we generate:
“The judgment is N_{g} more (if g>0)/less (if g<0) tolerant for a value of the parameter N^{o}i lying between yᵢ and y̅ᵢ̅ (if the parameter N^{o}i is continuous and iεC), for the value of the parameter N^{o}i equal to yᵢ (if the parameter N^{o}i is discrete).”
   We indicate thereafter the secondary parameters which have not counted at all in the result. We denote by D the set of these secondary parameters. This set D is determnined as follows. A continuous secondary parameter N^{o}i belongs to this set D if [yᵢ, y̅ᵢ̅] is equal to the domain of definition of this parameter. A discrete secondary parameter N^{o}i belongs to this set D if u(x; y₁, . . . , yᵢ₋₁, yᵢ′, yᵢ₊₁, . . . , yₙ)=v for any y′ᵢ in this parameter. If D corresponds to the set of secondary parameters, we generate the following text:
“The context has not counted in the judgment”.
   In the converse case, we generate the following text:
“The judgment does not depend on the secondary parameters D.”

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method of generating a text explaining the result of the application of a value judgment function in a given domain of application, according to which the judgment function depends mainly on a main parameter and in a secondary manner on at least one secondary parameter constructing by asking an expert in the domain of application considered to provide the main parameter and the list of secondary parameters, and to specify the mono-dimensional function which, for determined values of the secondary parameters, associateing the judgment with the main parameter, and by asking the expert how the mono-dimensional judgment function is modified as a function of the determined values of the secondary parameters, that the user provides the values of the main parameter and of the secondary parameters corresponding to at least one option to be evaluated, that the result of the judgment is calculated for each option by determining the mono-dimensional judgment function dependent on the main parameter on the basis of the values of the secondary parameters and by applying this function to the value of the main parameter, and that a text is generated for the user comprising a list of results of this judgment function for each option.

2. The method as claimed in claim 1, wherein the mono-dimensional judgment function dependent on the main parameter in a given context is specified on the basis of a finite number of values selected of the main parameter by the expert and of the values that the judgment takes for these values in the preceding context, and the mono-dimensional judgment function for the other contexts is deduced from the preceding function by indicating how the selected values, specifying the mono-dimensional judgment function, depend on the context, the results of the judgment for the selected values remaining the same.

3. The method as claimed in claim 2, wherein the expert gives the selected values of the main parameter for a certain number of key contexts provided by the expert, and the selected values for a new context are calculated by interpolation on the basis of the key contexts previously provided.

4. The method as claimed in claim 3, wherein the expert orders the secondary parameters according to their influence on the judgment function, and, to calculate the values selected from the context of the option, a procedure is applied recursively consisting in determining the key contexts stripped of the last parameter together with the associated selected values, by interpolating with respect to the last parameter between all the key contexts reducing to one and the same context stripped of the last parameter, until there is no longer any secondary parameter, and the selected values for the context of the option are thus obtained, and an interpolation is carried out between these selected values and the associated judgments to deduce therefrom the judgment.

5. The method as claimed in claim 4, wherein the interpolation carried out is linear for the continuous parameters.

6. The method as claimed in claim from 1, wherein the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.

7. The method as claimed in claim 6, wherein after the expert has provided a reference context, the judgment of the option is evaluated by replacing its context with the reference context, the difference between the judgment of the option and the preceding judgment is evaluated, the important secondary parameters are determined, that is to say those having counted significantly in explaining the difference in the two judgments, and the important secondary parameters are provided to the expert.

8. The method as claimed in claim 7, wherein the set of differences is split into 2t+1 ordered levels N₋ₜ*, . . . , N₀*, . . . , Nₜ*, the level N₋ₜ* being the worst, the level N₀* being average, that is to say neither good nor bad, Nₜ* being the best level, each level being characterized by a minimum value and a maximum value, for the option the level Nₛ* is determined corresponding to the difference between the results of the two judgments, we indicate when s>0 that the judgment is Nₛ* more tolerant than for the reference context and, when s<0, that the judgment is Nₛ* less tolerant than for the reference context.

9. The method as claimed in claim 8, wherein the bounds of the interval surrounding the value of the option according to this parameter are determined for which, by replacing the value of the secondary parameter considered with any value belonging to the interval, the difference between the result of the judgment of the option and the result of the judgment of the option obtained by replacing its context with the reference context, is evaluated Nₛ*, a text is generated indicating, for each important secondary parameter, that the judgment is Nₛ* more (if s>0) or less (if s<0) tolerant when this secondary parameter belongs to the previously determined interval, that the judgment is indicated not to depend on a certain secondary parameter if the previously calculated bounds for this parameter are equal to the domain of definition of this parameter the bounds of the interval surrounding the value of the option according to this parameter for which, by replacing the value of the secondary parameter considered with any value belonging to the interval, the difference between the result of the judgment of the option and the result of the judgment of the option obtained by replacing its context with the reference context, is evaluated Nₛ*, a text is generated indicating, for each important secondary parameter, that the judgment is Nₛ* more (if s>0) or less (if s<0) tolerant when this secondary parameter belongs to the previously determined interval, that the judgment is indicated not to depend on a certain secondary parameter if the previously calculated bounds for this parameter are equal to the domain of definition of this parameter.

10. The method as claimed in claim 2, wherein the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.

11. The method as claimed in claim 3, wherein the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.

12. The method as claimed in claim 4, wherein the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.

13. The method as claimed in claim 5, wherein the set of evaluations is split into 2m+1 ordered levels N₋ₘ, . . . , N₀, . . . , Nₘ, the level N₋ₘ being the worst, the level N₀ being average, that is to say neither good nor bad, Nₘ being the best level, each level being characterized by a minimum value and a maximum value, for the option the level Nₖ corresponding to its evaluation by the model is determined, the bounds of the interval surrounding the value of the option according to the main parameter are determined for which, when the value of the main parameter is replaced with any value belonging to the interval, the judgment of the option is evaluated Nₖ, a text is generated indicating that when the main parameter belongs to the previously determined interval, the judgment belongs to the level Nₖ, and an explanation of the judgment is thus produced as a function of the main parameter.
